(19) United States
(12) Patent Application Publication
(10) Pub. No.: US 2026/0254584 A1
(43) Pub. Date: Aug. 27, 2026

(54) INFORMATION TRANSMISSION METHODS AND APPARATUSES, COMMUNICATION DEVICE AND STORAGE MEDIUM

(71) Applicant: Beijing Xiaomi Mobile Software Co., Ltd., Beijing (CN)

(72) Inventor: Xiaolong LI, Beijing (CN)

(73) Assignee: Beijing Xiaomi Mobile Software Co., Ltd., Beijing (CN)

(21) Appl. No.: 19/160,905

(22) PCT Filed: Mar. 1, 2023
(86) PCT No.: PCT/CN2023/079150

§ 371 Date: Aug. 29, 2025

(51) Int. Cl. H04L 5/00; H04L 5/14; H04W 8/22; H04W 28/02

(52) U.S. Cl. CPC H04L 5/0051; H04L 5/14; H04W 8/22; H04W 28/0268

(57) ABSTRACT

The embodiments of the present disclosure provide an information transmission method. The method includes: receiving a first request sent by a sensing network element. The first request indicates the access network element to send a sensing reference signal or to receive the sensing reference signal.

### CROSS REFERENCE TO RELATED APPLICATION

The present application is a U.S. National Stage of International Application No. PCT/CN2023/079150, filed on Mar. 1, 2023, the contents of which are incorporated herein by reference in its entirety.

### TECHNICAL FIELD

The present disclosure relates to, but is not limited to, the wireless communication technical field, and in particular to an information transmission method and apparatus, a communication device, and a storage medium.

### BACKGROUND

The communication and sensing fusion in 5G systems specified by the 3rd Generation Partnership Project (3GPP) mainly explores the use of wireless channel characteristics based on the 5G basic network architecture and air interface enhancement design to obtain richer environmental information and realize basic sensing applications.

The integrated sensing and communication technology refers to combination of two functions (i.e., wireless communication and sensing), enabling wireless communication systems to simultaneously have both functions, i.e., communication and sensing. While a device transmits wireless signals, the device actively detects reflected/diffracted signals to sense physical characteristics of its surroundings, thereby realize mutual enhancement of the communication and sensing functions. For example, a base station uses signals to sense information about its surroundings and design communication links to avoid obstacles, thus improving communication performance.

### SUMMARY

Embodiments of the present disclosure provide an information transmission method and apparatus, a communication device, and a storage medium.

A first aspect of an embodiment of the present disclosure provides an information transmission method. The method is performed by an access network element. The method includes:
receiving a first request sent by a sensing network element, wherein the first request indicates the access network element to send a sensing reference signal or to receive a sensing reference signal.

A second aspect of an embodiment of the present disclosure provides an information transmission method. The method is performed by a sensing network element. The method includes:
sending a first request to an access network element, wherein the first request indicates the access network element to send a sensing reference signal or to receive a sensing reference signal.

A third aspect of an embodiment of the present disclosure provides an information transmission apparatus. The apparatus is applied to an access network element. The apparatus includes:
a transceiving module configured to receive a first request sent by a sensing network element, wherein the first request indicates the access network element to send a sensing reference signal or to receive a sensing reference signal.

A fourth aspect of an embodiment of the present disclosure provides an information transmission apparatus. The apparatus is applied to a sensing network element. The apparatus includes:
a transceiving module configured to send a first request to an access network element, wherein the first request indicates the access network element to send a sensing reference signal or to receive a sensing reference signal.

A fifth aspect of an embodiment of the present disclosure provides a communication system. The communication system includes:
an access network element configured to perform the information transmission method provided in the first aspect as described above; and
a sensing network element configured to perform the information transmission method provided in the second aspect as described above.

A sixth aspect of an embodiment of the present disclosure provides a communication device, including a processor, a memory, and an executable program stored in the memory and capable of being run by the processor. When the processor runs the executable program, the information transmission method provided in the first or second aspect as described above is implemented.

A seventh aspect of an embodiment of the present disclosure provides a non-transitory computer storage medium, which stores an executable program. After the executable program is executed by a processor, the information transmission method provided in the first or second aspect as described above can be implemented.

It should be understood that the foregoing general description and the following detailed description are merely illustrative and explanatory and are not restrictive of the embodiments of the present disclosure.

### BRIEF DESCRIPTION OF THE DRAWINGS

The accompanying drawings, which are incorporated in and constitute a part of the specification, illustrate embodiments consistent with the present disclosure and, together with the specification, serve to explain the principles of the embodiments of the present disclosure.

FIG. 1 is a schematic structural diagram of a wireless communication system according to an example embodiment.

FIG. 2a is a schematic structural diagram of a wireless communication system according to an example embodiment.

FIG. 2b is a schematic structural diagram of a wireless communication system according to an example embodiment.

FIG. 2c is a schematic structural diagram of a wireless communication system according to an example embodiment.

FIG. 3 is a schematic flowchart of an information transmission method according to an example embodiment.

FIG. 4 is a schematic flowchart of an information transmission method according to an example embodiment.

FIG. 5 is a schematic flowchart of an information transmission method according to an example embodiment.

FIG. 6 is a schematic flowchart of an information transmission method according to an example embodiment.

FIG. 7 is a schematic flowchart of an information transmission method according to an example embodiment.

FIG. 8 is a schematic flowchart of an information transmission method according to an example embodiment.

FIG. 9 is a schematic flowchart of an information transmission method according to an example embodiment.

FIG. 10 is a schematic flowchart of an information transmission method according to an example embodiment.

FIG. 11 is a schematic flowchart of an information transmission method according to an example embodiment.

FIG. 12 is a schematic flowchart of an information transmission method according to an example embodiment.

FIG. 13 is a schematic flowchart of an information transmission method according to an example embodiment.

FIG. 14 is a schematic flowchart of an information transmission method according to an example embodiment.

FIG. 15 is a schematic flowchart of an information transmission method according to an example embodiment.

FIG. 16 is a schematic flowchart of an information transmission method according to an example embodiment.

FIG. 17a is a schematic flowchart of an information transmission method according to an example embodiment.

FIG. 17b is a schematic flowchart of an information transmission method according to an example embodiment.

FIG. 18a is a schematic structural diagram of an information transmission apparatus according to an example embodiment.

FIG. 18b is a schematic structural diagram of an information transmission apparatus according to an example embodiment.

FIG. 19 is a schematic structural diagram of a communication device according to an example embodiment.

### DETAILED DESCRIPTION

Example embodiments are described in detail herein, with examples illustrated in the accompanying drawings. When the following description refers to the drawings, identical numerals in different drawings represent identical or similar elements unless otherwise indicated. The embodiments described in the following example embodiments are not intended to represent all possible implementations consistent with the present disclosure. Rather, they are merely examples of apparatuses and methods consistent with certain aspects of the present disclosure.

The terms used in the embodiments of the present disclosure are for the purpose of describing example embodiments only and are not intended to limit the embodiments of the present disclosure. The singular forms “a/an,” “the,” and “said” used in the present disclosure are also intended to include plural forms unless the context clearly indicates otherwise. It should also be understood that the term “and/or” used herein refers to and includes any one or all possible combinations of one or more associated listed items.

It should be understood that although the terms first, second, third, etc. may be used to describe various information in the embodiments of the present disclosure, such information should not be limited to these terms. These terms are only used to distinguish information of the same type from each other. For example, without departing from the scope of the embodiments of the present disclosure, first information may also be referred to as second information, and similarly, second information may also be referred to as first information. Depending on the context, the word “if” as used herein may be interpreted as “at the time of” or “when” or “in response to determining.” .

The network architecture and service scenarios described in the embodiments of the present disclosure are intended to more clearly illustrate the technical solutions of the embodiments of the present disclosure, and do not constitute a limitation on the technical solutions provided by the embodiments of the present disclosure. A person skilled in the art will appreciate that with the evolution of network architecture and the emergence of new service scenarios, the technical solutions provided by the embodiments of the present disclosure are equally applicable to similar technical problems.

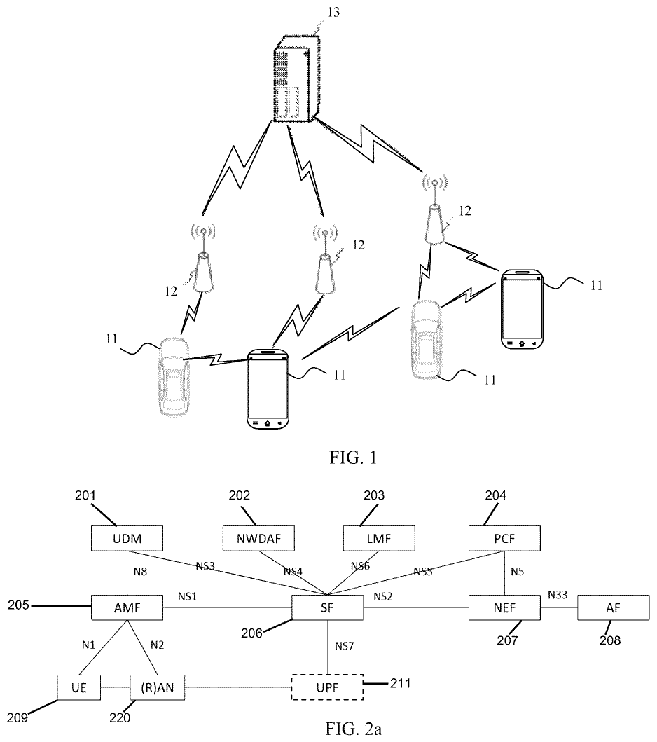

FIG. 1 is a schematic structural diagram of a wireless communication system according to an example embodiment. To facilitate understanding of the embodiments of the present disclosure, the wireless communication system shown in FIG. 1 is first used as an example to describe in detail a wireless communication system applicable to the embodiments of the present disclosure. It should be noted that the solutions in the embodiments of the present disclosure may also be applied to other wireless communication systems, and the corresponding names may be replaced with the names of corresponding functions in other wireless communication systems.

As shown in FIG. 1, the wireless communication system is a communication system based on cellular mobile communication technologies. The wireless communication system may include: several UEs 11, several access devices 12 and a core network device 13.

A UE 11 may refer to a device that provides voice and/or data connectivity to a user. The UE 11 may communicate with one or more core networks via a Radio Access Network (RAN). The UE 11 may be Internet of Things user equipment, such as a sensor device, a mobile phone (or called “cellular” phone), and a computer with Internet of Things user equipment. For example, it may be a fixed, portable, pocket-sized, handheld, computer-built-in, or vehicle-mounted apparatus. For example, it may be a station (STA), a subscriber unit, a subscriber station, a mobile station, a mobile, a remote station, an access point, a remote terminal, an access terminal, a user terminal, a user agent, a user device, or user equipment. Alternatively, the UE 11 may be a wearable device, a Virtual Reality (VR) device, an Augmented Reality (AR) device, or a VR/AR hybrid headset. Alternatively, the UE 11 may be a device on an unmanned aerial vehicle. Alternatively, the UE 11 may be a vehicle-mounted device, such as an on-board computer with wireless communication functions, or a wireless user device connected to an on-board computer. Alternatively, the UE 11 may be a roadside device, such as a streetlight, a signal light, or other roadside device with wireless communication functions.

An access device 12 may be a network-side device in a wireless communication system. The access device is a network-side entity used to transmit or receive signals, such as a next-generation base station (next-generation Node B, gNodeB). An access device may be a device used to communicate with a mobile device. The access device may be used to perform inter-conversion of received air frames and IP packets, acting as a router between a wireless terminal and the rest of an access network. The rest of the access network may include an Internet Protocol (IP) network. The network device may also coordinate the management of air interface attributes. The wireless communication system may be a fourth-generation mobile communication technology (4G) system, also known as a Long Term Evolution (LTE) system; or, the wireless communication system may be a 5G system, also called as a New Radio (NR) system or a 5G NR system. Alternatively, the wireless communication system may be a next generation system after the 5G system. The access network in the 5G system may be referred to as a New Generation-Radio Access Network (NG-RAN).

The access device 12 may be an evolved access device (eNB) used in a 4G system. Alternatively, the access device 12 may be an access device (gNB) using a centralized distributed architecture in a 5G system. When the access device 12 uses a centralized distributed architecture, it typically includes a central unit (CU) and at least two distributed units (DU). The central unit is provided with a protocol stack including a Packet Data Convergence Protocol (PDCP) layer, a Radio Link Control (RLC) protocol layer, and a Media Access Control (MAC) layer; the distributed unit is provided with a physical (PHY) layer protocol stack. The embodiments of the present disclosure do not limit the specific implementation of the access device 12.

A wireless connection may be established between an access device 12 and a UE 11 via a wireless air interface. In different implementations, the wireless air interface may be a wireless air interface based on the fourth-generation mobile communication network technology (4G) standard; or, the wireless air interface may be a wireless air interface based on the fifth-generation mobile communication network technology (5G) standard, e.g., the wireless air interface is a new air interface; or, the wireless air interface may be a wireless air interface based on a next-generation mobile communication network technology standard of 5G.

An End to End (E2E) or Device to Device (D2D) connection may be established between UEs 11, for example, including a Vehicle to Vehicle (V2V) communication, a Vehicle to Infrastructure (V2I) communication, and a Vehicle to Pedestrian (V2P) communication in a Vehicle-to-everything (V2X) communication.

In some examples, the access device 12 may be an access device in a Terrestrial Network (TN), or an NTN device having all or part of the functions of an access network.

The NTN device may be, for example, a satellite, a High Altitude Platform System (HAPS), or an Air To Ground (ATG) device deployed in the NTN.

As an example, the access device 12 may be located in a communication system integrated with a satellite communication system and capable of providing connection services for the satellite, thereby connecting the satellite to a core network. For example, the access device 12 may be an access device with a satellite gateway function in the communication system, such as a gateway device, a ground station device, a non-terrestrial networks gateway/satellite gateway (NTN-Gateway), etc.

As an example, the wireless communication system may further include a core network device 13. Several access devices 12 are respectively connected to the core network device 13. The core network device 13 may be an Access and Mobility Management Function (AMF), a User Plane Function (UPF), a Policy Control Function (PCF), or the like. The embodiments of the present disclosure do not limit the implementation form of the core network device 13. In an example, the core network device 13 is a Sensing Function (SF) network element, which is a functional network element that provides a sensing service.

The AMF, UPF, and SF in the embodiments of the present disclosure may each be implemented by a single physical device or by multiple physical devices. It is understood that the AMF, UPF, and SF in the embodiments of the present disclosure may each be a logical functional module within a physical device or a logical functional module formed by multiple physical devices, and the embodiments of the present disclosure do not impose specific limitations on this.

It should be noted that the network architecture shown in FIG. 1 is only an example applicable to the embodiments of the present disclosure and does not constitute a limitation on the scope of application of the embodiments of the present disclosure.

To facilitate understanding of those skilled in the art, the embodiments of the present disclosure list multiple implementations to clearly illustrate the technical solutions of the embodiments of the present disclosure. Of course, those skilled in the art can understand that the multiple embodiments provided in the embodiments of the present disclosure may be implemented individually, or may be implemented in combination with methods of other embodiments in the embodiments of the present disclosure, or can be performed individually or in combination with some methods in other related technologies, and embodiments of the present disclosure do not limit this.

In the mobile communication field, the communication and sensing fusion is still in its early stages. In the current 5G-A phase, the focus is on exploring the use of wireless channel characteristics to obtain richer environmental information and implement basic sensing applications based on the 5G basic network architecture and air interface enhancement design.

The integrated sensing and communication technology uses wireless signals to sense targets or their status in a surrounding environment. A wireless-side terminal or base station collects information such as signal strength, delay, phase change, or Doppler frequency shift, and outputs a result (such as a size of a target, a position, or a speed, etc.) through calculation and processing. During this procedure, a network needs to trigger, modify, or terminate a sensing procedure based on service requirement(s), schedule radio resources, process data, and expose result(s).

In the discussion of the integrated sensing and communication technology, introducing a sensing network element is considered. The sensing network element may have the following functions:

How to convert sensing Quality of Service (QOS) parameters: To meet a QoS requirement of a sensing service, QoS parameter conversion is required. Information such as a sensing service type or identity, QoS requirement(s) and sensing measurement data, reporting period, etc. is delivered to a terminal or a base station performing sensing. If a sensing requirement changes, such as a sensing area, data reporting time, or QoS requirements, etc., the terminal or application needs to trigger a corresponding modification procedure.

How to trigger a sensing service: for example, how to terminate a sensing service, how to control a base station or a terminal to perform sensing according to a sensing service requirement, how to efficiently process sensing measurement data, how to provide or expose sensing result(s).

Regarding a sensing mode, a function that receives a sensing signal and performs a sensing measurement is generally referred to as a sensing party. In a mobile communication network, a sensing party may be a base station or a terminal. Depending on whether the sensing party itself transmits a sensing signal, sensing may be categorized as active sensing or passive sensing. For example, using a base station as a sensing party, in the uplink, the base station may receive a signal sent by a UE for sensing, or the base station may receive a signal from other base station(s) for sensing, or the base station may receive a signal sent by the base station itself for active sensing.
1) A base station self-transmission and self-reception sensing mode: a base station RRU (Remote Radio Unit) or a BS (Base Station) uses a reflected/diffracted signal of its own transmitted communication signal for sensing. This is typically considered in a system where a sensing receiver and a transmitter are jointly deployed at a same position, such as a single-station radar. This base station self-transmission and self-reception sensing mode enables the BS to sense information about its surrounding environment. Because the transmitter and receiver are on the same platform, they can be easily synchronized at the clock level, and the sensing result can be clearly interpreted by the single base station node without the assistance of an external device.
2) A sensing mode based on transmission and reception between base stations (e.g., a base station A performs transmission, and a base station B performs reception) mode: the sensing mode based on transmission and reception between base stations refers to a situation where an RRU or a base station uses a downlink communication signal received from other RRU(s) or base station(s) for sensing. In terms of sensing, this is equivalent to dual-station and multi-station radar arrangement, where a transmitter and a receiver are spatially separated but their clocks are required to be synchronized.

In the related art, there is still a lack of specific sensing procedure(s) and sensing message(s) for the sensing mode based on base station self-transmission and self-reception and the sensing mode based on transmission and reception between base stations.

In the present disclosure, a sensing reference signal may include: a communication signal and/or an echo signal of the communication signal (e.g., a reflection signal and/or a diffraction signal).

It should be understood that the “sensing reference signal” in the present disclosure may be replaced by “sensing signal”.

In the present disclosure, the access network element may be a base station, for example, the base station may be an LTE eNB, or an NR gNB, or an ng-eNB, or an en-gNB, or other evolved base station.

In the present disclosure, the sensing network element may be replaced by a sensing function network element or a Sensing Application Function (SAF) network element.

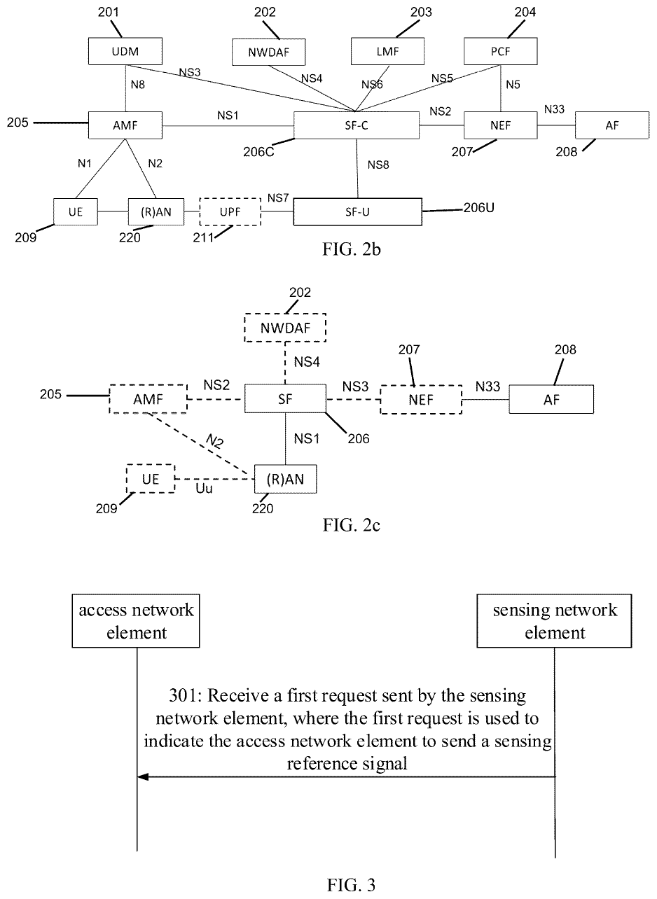

In the present disclosure, the sensing network element and the access network element (RAN) may communicate with each other using one of the following methods:
Method 1: the SF may communicate with the RAN through an AMF (including a control plane and a data plane). As shown in FIG. 2a, the SF 206 may communicate with the AMF 205 through an NS1 interface or may communicate with a UPF 211 through an NS7 interface. The AMF may communicate with a UE 209 through an N1 interface and may communicate with the RAN 220 through an N2 interface, and the RAN may communicate with the UPF. The AMF may communicate with a Unified Data Management (UDM) 201 function through an N8 interface and may communicate with the SF through an NS3 interface. The SF may communicate with a Network Data Analytics Function (NWDAF) 202 through an NS4 interface and may communicate with a Location Management Function (LMF) 203 through an NS6 interface. The SF may communicate with a PCF 204 through an NS5 interface and may communicate with a Network Exposure Function (NEF) 207 through an NS2 interface. An Application Function (AF) may communicate with the NEF through an N33 interface, and the NEF 207 may communicate with the PCF through an N5 interface.
Method 2: for an architecture in which a control plane and a data plane are separated, the SF exchanges control plane data with the RAN through the AMF, and exchanges data plane data with the RAN through the UPF. As shown in FIG. 2b, the SF 206 includes an SF-C (an SF control plane) 206C and an SF-U (an SF user plane) 206U. The SF-C may communicate with the AMF 205 through the NS1 interface, and the SF-U may communicate with the UPF 211 through the NS7 interface. The AMF 205 may communicate with a UE 209 through the N1 interface, and may communicate with the RAN 220 through the N2 interface, and the RAN may communicate with the UPF 211. The AMF may communicate with the Unified Data Management (UDM) 201 through the N8 interface and may communicate with the SF-C through the NS3 interface. The SF-C may communicate with the Network Data Analytics Function (NWDAF) 202 through the NS4 interface and may communicate with the Location Management Function (LMF) 203 through the NS6 interface. The SF-C may communicate with the PCF 204 through the NS5 interface and may communicate with the Network Exposure Function (NEF) 207 through the NS2 interface. The Application Function (AF) 208 may communicate with the NEF 207 through the N33 interface, and the NEF 207 may communicate with the PCF 204 through the N5 interface.
Method 3: the SF 206 communicates directly with the RAN 220 (not through the core network). As shown in FIG. 2c, the SF 206 may communicate directly with the RAN 220 through the NS1 interface and may communicate with the AMF 205 through the NS2 interface. The RAN 220 may communicate with the AMF 205 through the N2 interface and may communicate with a UE 209 through an Uu interface. The SF 206 may communicate with the Network Data Analytics Function (NWDAF) 202 through the NS4 interface and may communicate with the Network Exposure Function (NEF) 207 through the NS3 interface. The Application Function (AF) 208 may communicate with the NEF 207 through the N33 interface.

It should be understood that embodiments of the present disclosure do not limit the specific communication method between the sensing network element and the RAN.

FIG. 3 is a flowchart of an information transmission method according to an example embodiment. The information transmission method is performed by an access network element. As shown in FIG. 3, the method may include the following step:

In 301, a first request sent by a sensing network element is received. The first request is used to indicate the access network element to send a sensing reference signal.

In this embodiment, the access network element may be a base station, and the base station may be an LTE eNB, or an NR gNB, or an ng-eNB, or an en-gNB, or other evolved base station(s).

For example, taking a base station as an example, in a case that the base station supports a base station self-transmission and self-reception sensing mode, the sensing reference signal sent by the base station can be received by the base station. In a case that the base station supports a sensing mode based on transmission and reception between base stations, the sensing reference signal sent by the base station can be received by other base station(s) than the base station.

In some examples, the first request may be sent by the sensing network element according to capability information of the access network element.

The capability information of the access network element is used to indicate a sensing capability of the access network element, for example, indicating a self-transmission and self-reception capability of the access network element for the sensing reference signal, or indicating that the access network element has a full-duplex capability.

In some examples, before receiving the first request sent by the sensing network element, the method may further include:
sending the capability information of the access network element to the sensing network element.

In an embodiment, the first request is further used to indicate at least one of:
configuration information recommended by the sensing network element, where the recommended configuration information is used for the access network element to determine a sensing reference signal configuration;
requesting the access network element to send the sensing reference signal configuration to the sensing network element;
a sensing target type;
a sensing function or a sensing scenario of sensing; or
a QoS requirement.

In some examples, the configuration information recommended by the sensing network element may be determined by the sensing network element according to the capability information of the access network element.

In some examples, the recommended configuration information may be configured by the sensing network element for the access network element, or may be determined by the sensing network element from configuration information reported by the access network element.

In some examples, the configuration information includes at least one of:
a sensing target type to which the sensing reference signal is applied;
a sensing function or a sensing scenario to which the sensing reference signal is applied;
resource indication information for receiving the sensing reference signal;
resource indication information for sending the sensing reference signal.

Here, when the configuration information includes the sensing target type, it means that the sensing reference signal is used for a sensing measurement for the target type. When the configuration information includes the sensing function, it means that the sensing reference signal is used for a sensing measurement for the sensing function. When the configuration information indicates the sensing scenario, it means that the sensing reference signal is used for a sensing measurement for the sensing scenario.

In some examples, the configuration information may include at least one of: an identity of a sensing reference signal, an identity of a target type to which the sensing reference signal is applied, an identity of a sensing scenario, an identity of a sensing function, and resource indication information.

In some examples, the sensing target type is used to indicate the type of a target to which the sensing reference signal is applied. The target may be a mobile target, such as a vehicle, a person, an animal, etc., or the target may be a stationary target, such as a building, a fixed terminal, etc.

In some examples, the sensing scenario includes, but is not limited to: weather monitoring, traffic monitoring, and/or channel environment sensing, etc.

In some examples, the sensing function includes, but is not limited to: respiratory monitoring, invasion monitoring, fitness monitoring, gesture/posture recognition, etc.

In some examples, the resource indication information includes at least one of: a frequency domain resource configuration, an antenna configuration, a beam configuration, a time-frequency resource configuration, or a transmission period. For example, the frequency domain resource configuration may include a frequency point and/or a frequency band.

In some examples, different sensing reference signals may be applied to different sensing target types, or different sensing functions, or different sensing scenarios. Here, different sensing reference signals may be sensing reference signals with different radio resources. For example, different sensing reference signals may have different baseband waveforms, bandwidths, and/or subcarrier spacing.

For example, a transmission period of a sensing reference signal applied to a target type which is a vehicle is smaller than a transmission period of a sensing reference signal applied to a target type which is a pedestrian.

For another example, time-frequency resources for a sensing reference signal applied to a sensing scenario which is a gesture recognition scenario are greater time-frequency resources for a sensing reference signal applied to a sensing scenario which is a traffic monitoring scenario.

For example, a transmission period of a sensing reference signal applied to a vehicle is higher than a transmission period of a sensing reference signal applied to a pedestrian.

For another example, time-frequency resources for a sensing reference signal applied to gesture recognition are greater than time-frequency resources for a sensing reference signal applied to traffic monitoring.

In some examples, the access network element may determine a sensing reference signal configuration based on the configuration information recommended by the sensing network element, and sends the sensing reference signal according to the determined sensing reference signal configuration.

In some examples, when the first request indicates a QoS requirement, the access network element performs QoS parameter conversion on the sent sensing reference signal according to the QoS requirement. The QoS parameter may be for example used to indicate a priority level, a delay level and/or a reliability level, etc.

In some examples, the sensing reference signal configuration is used to indicate at least one of:
a sensing target type to which the sensing reference signal is applied;
a sensing function or a sensing scenario to which the sensing reference signal is applied; or
resource indication information for sending the sensing reference signal.

In some examples, the first request may further be used to indicate the access network element to receive the sensing reference signal.

In some examples, the first request may further be used to indicate the access network element to determine the sensing reference signal.

In some examples, in a case that the first request indicates the access network element to receive the sensing reference signal, the first request is further used to indicate acquisition of a sensing measurement result of the access network element for the received sensing reference signal.

In the information transmission method provided by the embodiments of the present disclosure, the access network element receives the first request sent by the sensing network element. The first request is used to indicate the access network element to send the sensing reference signal. In this way, the access network element can send the sensing reference signal in accordance with the first request sent by the sensing network element, thereby improving the sensing procedure initiated by the sensing network element towards the access network element.

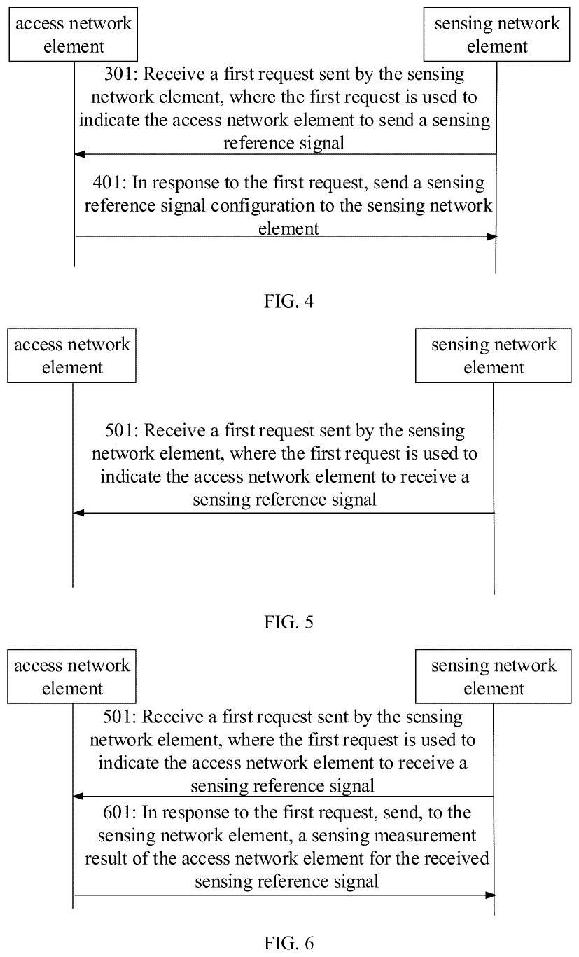

In an embodiment, as shown in FIG. 4, based on FIG. 3, the method further includes the following step:

In 401, in response to the first request, the sensing reference signal configuration is sent to the sensing network element.

In this embodiment, when the first request indicates the access network element to send the sensing reference signal configuration to the sensing network element, the access network element sends the sensing reference signal configuration to the sensing network element in response to the first request, so that the sensing network element can obtain the configuration for the access network element to send the sensing reference signal.

An embodiment of the present disclosure provides an information transmission method. The method is performed by an access network element. As shown in FIG. 5, the method includes the following step:

In 501, a first request sent by a sensing network element is received. The first request is used to indicate the access network element to receive a sensing reference signal.

In some examples, the access network element may be a base station, which may be an LTE eNB, or an NR gNB, or an ng-eNB, or an en-gNB, or other evolved base station(s).

For example, taking a base station as an example, in a case that the base station supports a base station self-transmission and self-reception sensing mode, the sensing reference signal sent by the base station can be received by the base station. In a case that the base station supports a sensing mode based on transmission and reception between base stations, the sensing reference signal sent by the base station can be received by other base station(s) than the base station.

In some examples, the first request may be sent by the sensing network element according to capability information of the access network element.

The capability information of access network element is used to indicate a sensing capability of the access network element, for example, indicating a sending capability and/or a receiving capability of the access network element for the sensing reference signal.

In some examples, the capability information of the access network element indicates that the access network element has a full-duplex capability.

In some examples, before receiving the first request sent by the sensing network element, the method may further include:
sending the capability information of the access network element to the sensing network element, where the capability information is used to indicate the sensing capability of the access network element.

In some examples, in a case that the first request indicates the access network element to receive the sensing reference signal, the first request is further used to indicate acquisition of a sensing measurement result of the access network element on the received sensing reference signal.

In an embodiment, the first request is further used to indicate at least one of:
a sensing reference signal configuration for the access network element to receive the sensing reference signal;
the type of a target that needs to be sensed;
the maximum number of targets that needs to be sensed;
a sensing function or a sensing scenario that needs to be sensed;
a measurement quantity of the sensing reference signal that needs to be measured;
a sensing result that needs to be calculated;
a sensing range, a carrier frequency and/or accuracy that needs to be sensed.

In some examples, the sensing target type is used to indicate a target to which the sensing reference signal is applied. The target may be a mobile target, such as a vehicle, a person, or a terminal, etc., or the target may be a stationary target. For example, the type of the target that needs to be sensed may be a vehicle. That is, if sensing of a vehicle is requested, the access network element is required to perform a vehicle-related sensing measurement on the received sensing reference signal and report a sensing measurement result with the vehicle as the target.

In some examples, the maximum number of targets that needs to be sensed may be used to indicate reporting sensing measurement result(s) in which the number of targets is less than or equal to the maximum number of targets.

In some examples, the sensing scenario that needs to be sensed may be used to indicate a specific application scenario of the sensing measurement performed by the access network element, such as weather monitoring, in which case the access network element needs to report a sensing measurement result related to weather monitoring.

As an example, the sensing function that needs to be sensed may be used to indicate a function of a UE to which the sensing measurement of the sensing reference signal is applied. For example, when the function is fitness monitoring, the access network element needs to report a sensing measurement result related to fitness monitoring.

In some examples, the measurement quantity of the sensing reference signal may include: a signal strength, a delay, a phase change and/or a Doppler frequency shift, etc.

In some examples, the sensing result that needs to be calculated may be, for example, a position, a speed, and/or an angle of a sensing target that needs to be calculated.

As an example, the sensing result that needs to be calculated may include at least one of:
a moving speed of a target, a position of the target relative to an access network element that sends the sensing reference signal, a distance between the target and the access network element that sends the sensing reference signal, an angle between the target and the access network element that sends the sensing reference signal, a position of the target relative to an access network element that receives the sensing reference signal, a distance between the target and the access network element that receives the sensing reference signal, or an angle between the target and the access network element that receives the sensing reference signal.

In an embodiment, the sensing reference signal configuration is used to indicate at least one of:
the type of a sensing target to which the sensing reference signal is applied;
a sensing function or a sensing scenario to which the sensing reference signal is applied; or
resource indication information for receiving the sensing reference signal.

In some examples, the first request may be further used to indicate the access network element to send the sensing reference signal.

In some examples, the first request may be further used to indicate the access network element to determine the sensing reference signal.

In the information transmission method provided by the embodiments of the present disclosure, the access network element receives the first request sent by the sensing network element. The first request is used to indicate the access network element to receive the sensing reference signal. In this way, the access network element can receive the sensing reference signal in accordance with the first request sent by the sensing network element, thereby improving the sensing procedure initiated by the sensing network element towards the access network element.

In an embodiment, as shown in FIG. 6, based on FIG. 5, the method further includes the following step:

In 601, in response to the first request, a sensing measurement result of the access network element for the received sensing reference signal is sent to the sensing network element.

In some examples, the sensing measurement result may include: a measurement result of the sensing reference signal and/or a sensing result.

In some examples, the sensing measurement result may include: a measurement result of the sensing reference signal applied to a target type, or a target sensing function, or a target sensing scenario.

In some examples, the sensing reference signal measurement result may include, but is not limited to: a measurement value such as a signal strength of the sensing reference signal, a delay, a phase change, and/or a Doppler frequency shift, etc.

In some examples, the sensing result may include: a sensing result applied to a target type, or a target sensing function, or a target sensing scenario.

In some examples, the sensing result applied to the target type may include, but is not limited to: a moving speed of the target, a position of the target relative to the base station, a distance between the target and the base station, and/or an angle between the target and the base station.

In some examples, the sensing result applied to the target sensing function may include, but is not limited to: a respiratory monitoring result, an invasion monitoring results, a fitness monitoring result, and/or a posture recognition result, etc.

In some examples, the sensing result applied to the target sensing scenario may include, but is not limited to: a weather monitoring result, a pedestrian flow statistics result, a traffic monitoring result and/or a channel environment sensing result, etc.

In some examples, the sensing measurement result may include: sensing signal measurement results and/or sensing results for all targets that can be sensed by the access network element.

In an embodiment, the access network element may perform sensing measurement on the received sensing reference signal in response to the first request, and report the sensing measurement result to the sensing network element.

In an embodiment, the sensing measurement result includes at least one of:
a sensing reference signal measurement result and/or a sensing result of a sensing target for a target type requested for sensing;
a sensing reference signal measurement result and/or a sensing result of a sensing target corresponding to a requested sensing function or sensing scenario;
a sensing reference signal measurement result and/or a sensing result of a sensing target not exceeding a maximum number of targets requested for sensing;
a target type associated with the sensing reference signal measurement result and/or the sensing result of the sensing target;
a sensing scenario associated with the sensing reference signal measurement result and/or the sensing result of the sensing target.

In some examples, the sensing reference signal measurement result may include: a result obtained by measuring the sensing reference signal based on a measurement quantity. For example, the measurement quantity may include information such as a signal strength, a delay, a phase change, and/or a Doppler frequency shift, etc.

The sensing result of the sensing target may include a result obtained by performing processing based on the measurement result of the sensing reference signal. For example, the sensing result may include the size, position, and/or speed of a target, etc. The processing may include superimposing, fusing, and/or analyzing of the measurement result(s) of the sensing reference signal, etc.

As an example, the target type associated with the sensing reference signal measurement result and/or the sensing result may be used to characterize a target associated with the sensing measurement performed by the access network element on the received sensing reference signal. For example, if the access network element performs vehicle-related sensing measurement on the received sensing reference signal to obtain a sensing measurement result, the target type associated with the sensing measurement result is a vehicle.

As an example, the sensing scenario associated with the sensing reference signal measurement result and/or the sensing result of the sensing target may be used to characterize a scenario to which the sensing measurement performed by the access network element on the received sensing reference signal is applied. For example, the scenario is: weather monitoring, environmental monitoring, or pedestrian flow statistics, etc.

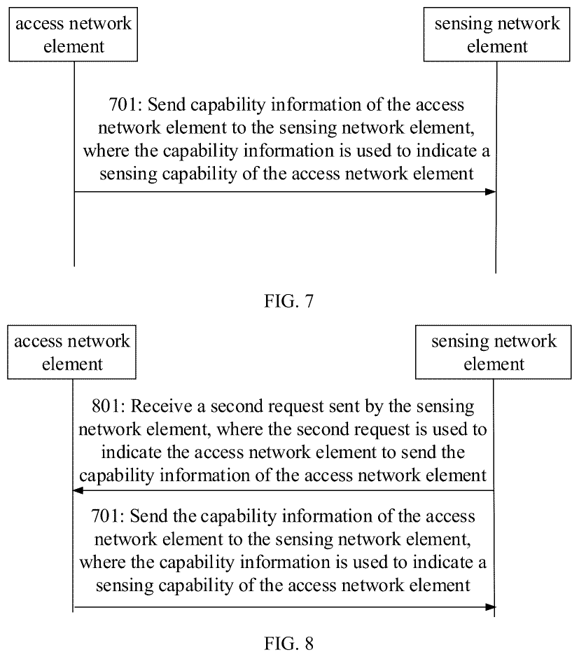

An embodiment of the present disclosure provides an information transmission method. The method is performed by an access network element. As shown in FIG. 7, the method includes the following step:

In 701, capability information of the access network element is sent to a sensing network element. The capability information is used to indicate a sensing capability of the access network element.

In some examples, the capability information is used to indicate at least one of:
a self-transmission and self-reception capability of the access network element;
a full duplex capability of the access network element;
a processing capability of the access network element for a received sensing reference signal;
a target type supported to be sensed by the access network element;
a sensing function or a sensing scenario supported by the access network element;
a measurement quantity of the access network element for the received sensing reference signal;
a sensing result supported to be calculated by the access network element.

In some examples, the self-transmission and self-reception capability of the access network element is used to determine whether the access network element supports a self-transmission and self-reception sensing mode of the access network element.

In some examples, the full-duplex capability of an access network element is used to determine whether the access network element supports a sensing mode based on transmission and reception between access network elements.

In some examples, the processing capability of the access network element for the received sensing reference signal is used to indicate at least one of:
the maximum number of targets supported to be sensed simultaneously, which may be for example, the number of targets that can be recognized by receiving a sensing reference signal once;
the maximum distance at which sensing of a target is supported; for example, if the maximum distance of the target is exceeded, the target cannot be sensed.

In some examples, the sensing function or sensing scenario may be, for example, weather monitoring, respiratory monitoring, invasion monitoring, fitness monitoring, gesture/posture recognition, and/or traffic monitoring.

In some examples, the measurement quantity of the sensing reference signal may include: a signal strength, a delay, a phase change and/or a Doppler frequency shift, etc.

In some examples, the sensing result supported to be calculated may be for example whether the position, speed and/or angle of the sensing target are supported to be calculated.

As an example, the sensing result may include at least one of:
a moving speed of a target, a position of the target relative to an access network element that sends the sensing reference signal, a distance between the target and the access network element that sends the sensing reference signal, an angle between the target and the access network element that sends the sensing reference signal, a position of the target relative to an access network element that receives the sensing reference signal, a distance between the target and the access network element that receives the sensing reference signal, or an angle between the target and the access network element that receives the sensing reference signal.

In some examples, the capability information of the access network element may be actively reported (e.g., periodically reported) by the access network element to the sensing network element. The sensing network element may store the capability information of the access network element.

In other examples, the access network element may send the capability information of the access network element to the sensing network element based on a sensing capability request sent by the sensing network element.

In some examples, the method may further include:
sending capability update information of the access network element to the sensing network element, where the capability update information is used to update the capability information of the access network element.

The sensing capability(capabilities) supported by the access network element may change. For example, the access network element may add sensing capability(capabilities) that needs(need) to be supported or reduce sensing capabilities that are already supported.

In some examples, the capability update information may indicate an added sensing capability or a reduced sensing capability of the access network element, or the capability update information may indicate updated sensing capability(capabilities) of the access network element.

In the embodiments, the access network element sends the capability information of the access network element to the sensing network element, so that the sensing network element can use the capability information of the access network element to initiate a sensing procedure towards the access network element, thereby ensuring the effectiveness of initiating of the sensing procedure.

In an embodiment, as shown in FIG. 8, based on FIG. 7, the method includes the following step:

In 801, a second request sent by a sensing network element is received. The second request is used to indicate the access network element to send the capability information of the access network element.

In this embodiment, the access network element may send the capability information of the access network element to the sensing network element in response to the second request sent by the sensing network element.

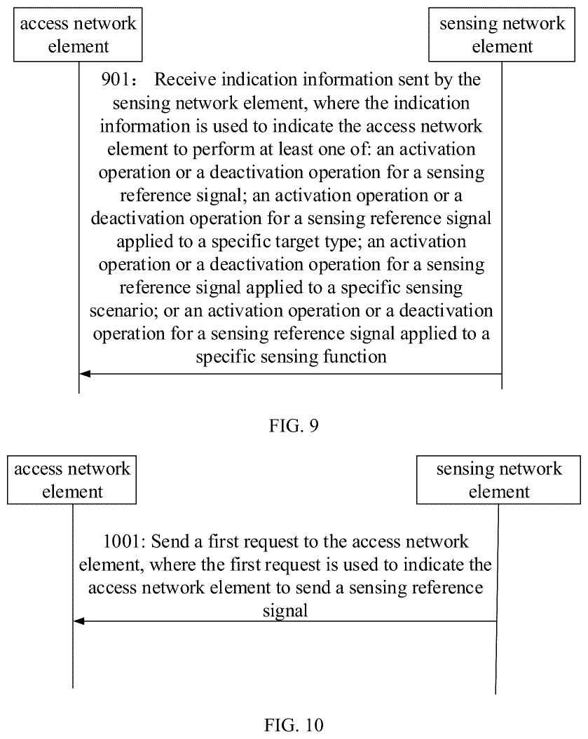

An embodiment of the present disclosure provides an information transmission method. The method is performed by an access network element. As shown in FIG. 9, the method includes the following step:

In 901, indication information sent by a sensing network element is received. The indication information is used to indicate the access network element to perform one of:
an activation operation or a deactivation operation for a sensing reference signal;
an activation operation or a deactivation operation for a sensing reference signal applied to a specific target type;
an activation operation or a deactivation operation for a sensing reference signal applied to a specific sensing scenario;
an activation operation or a deactivation operation for a sensing reference signal applied to a specific sensing function.

In some examples, when the indication information indicates the access network element to perform an activation operation, the indication information may include an identity of the sensing reference signal to be activated. Furthermore, the indication information may further include identity information of a specific target type, a specific sensing scenario, and/or a specific sensing function, to indicate the access network element to perform the activation operation for a specific sensing reference signal.

In some examples, when the indication information indicates the access network element to perform a deactivation operation, the indication information may include an identity of a sensing reference signal to be deactivated. Furthermore, the indication information may further include identity information of a specific target type, a specific sensing scenario, and/or a specific sensing function, to indicate the access network element to perform the deactivation operation for a specific sensing reference signal.

Here, an activation operation for a sensing reference signal refers to enabling (or starting) transmission and reception of the sensing reference signal.

Here, a deactivation operation for a sensing reference signal refers to disabling (or forbidding) transmission and reception of the sensing reference signal.

As an example, the indication information may be used to indicate the access network element to perform an activation operation for a sensing reference signal after a specified time, or to indicate the access network element to reactivate a sensing reference signal that has been deactivated before.

As an example, the indication information may be used to indicate the access network element to perform a deactivation operation for a sensing reference signal after a specified time, or to indicate the access network element to deactivate a sensing reference signal that has been activated before.

The specific target type may be any specified target type, such as a vehicle or a pedestrian. Compared to the transmission period and/or reception period of a sensing reference signal applied to a pedestrian, the transmission period and/or reception period of a sensing reference signal applied to a vehicle is shorter.

For example, if the indication information indicates the access network element to perform an activation operation for a sensing reference signal applied to a vehicle, the access network element may send and/or receive the activated sensing reference signal applied to the vehicle after performing the corresponding activation operation.

For example, if the indication information indicates the access network element to perform a deactivation operation for a sensing reference signal applied to a pedestrian, after the access network element performs the corresponding deactivation operation, the access network element cannot send and receive the deactivated sensing reference signal applied to the pedestrian.

The specific sensing scenario mentioned above may be any specified target sensing scenario, such as weather monitoring or invasion monitoring, etc. The specific sensing function mentioned above may be any specified target sensing function, for example, a sensing function such as channel environment sensing, etc.

In the embodiment, the access network element may perform the operation (activating or deactivating a corresponding sensing reference signal) indicated by the indication information sent by the sensing network element. In this way, flexible control over the sending or receiving of the sensing reference signal by the access network element can be achieved.

FIG. 10 is a flowchart of an information transmission method according to an example embodiment. The information transmission method is performed by a sensing network element. As shown in FIG. 10, the method may include the following step:

In 1001, a first request is sent to an access network element. The first request is used to indicate the access network element to send a sensing reference signal.

In this embodiment, the access network element may be a base station, and the base station may be an LTE eNB, or an NR gNB, or an ng-eNB, or an en-gNB, or other evolved base station(s).

For example, taking a base station as an example, in a case that the base station supports a base station self-transmission and self-reception sensing mode, the sensing reference signal sent by the base station can be received by the base station. In a case that the base station supports a sensing mode based on transmission and reception between base stations, the sensing reference signal sent by the base station can be received by other base station(s) than the base station.

In some examples, the first request may be sent by the sensing network element based on capability information of the access network element.

The capability information of the access network element is used to indicate a sensing capability of the access network element, for example, indicating a self-transmission and self-reception capability of the access network element for the sensing reference signal, or indicating that the access network element has a full-duplex capability.

In some examples, before sending the first request to the access network element, the method may further include:
receiving the capability information of the access network element.

In an embodiment, the first request is further used to indicate at least one of:
configuration information recommended by the sensing network element, where the recommended configuration information is used for the access network element to determine a sensing reference signal configuration;
requesting the access network element to send the sensing reference signal configuration to the sensing network element;
a sensing target type;
a sensing function or a sensing scenario of sensing; or
a QoS requirement.

In some examples, the configuration information recommended by the sensing network element may be determined by the sensing network element according to the capability information of the access network element.

In some examples, the recommended configuration information may be configured by the sensing network element for the access network element, or may be determined by the sensing network element from configuration information reported by the access network element.

In some examples, the configuration information includes at least one of:
a sensing target type to which the sensing reference signal is applied;
a sensing function or a sensing scenario to which the sensing reference signal is applied;
resource indication information for receiving the sensing reference signal; or
resource indication information for sending the sensing reference signal.

Here, when the configuration information includes the sensing target type, it means that the sensing reference signal is used for a sensing measurement for the target type. When the configuration information includes the sensing function, it means that the sensing reference signal is used for a sensing measurement for the sensing function. When the configuration information includes the sensing scenario, it means that the sensing reference signal is used for a sensing measurement for the sensing scenario.

In some examples, when the configuration information is used to indicate a sensing reference signal, the configuration information may include at least one of: an identity of the sensing reference signal, an identity of a target type to which the sensing reference signal is applied, an identity of a sensing scenario, an identity of a sensing function, and resource indication information.

In some examples, the sensing target type is used to indicate a target to which the sensing reference signal is applied. The target may be a mobile target, such as a vehicle, a person, an animal, etc., or the target may be a stationary target, such as a building, a fixed terminal, etc.

In some examples, the sensing scenario may include, but is not limited to, weather monitoring, traffic monitoring, and/or channel environment sensing, etc.

In some examples, the sensing function includes, but is not limited to, respiratory monitoring, invasion monitoring, fitness monitoring, gesture/posture recognition, etc.

In some examples, the resource indication information includes at least one of: a frequency domain resource configuration, an antenna configuration, a beam configuration, a time-frequency resource configuration, or a transmission period. For example, the frequency domain resource configuration may include a frequency point and/or a frequency band.

In some examples, different sensing reference signals may be applied to different sensing target types, or different sensing functions, or different sensing scenarios. Here, different sensing reference signals may be sensing reference signals with different radio resources. For example, different sensing reference signals may have different baseband waveforms, bandwidths, and/or subcarrier spacing.

For example, a transmission period of a sensing reference signal applied to a target type which is a vehicle is smaller than a transmission period of a sensing reference signal applied to a target type which is a pedestrian.

For another example, the time-frequency resources for a sensing reference signal applied to a sensing scenario which is a gesture recognition scenario are greater than the time-frequency resources for a sensing reference signal applied to a sensing scenario which is a traffic monitoring scenario.

For example, a transmission period of a sensing reference signal applied to a vehicle is higher than a transmission period of a sensing reference signal applied to a pedestrian.

For another example, the time-frequency resources for a sensing reference signal applied to gesture recognition are greater than the time-frequency resources for a sensing reference signal applied to traffic monitoring.

In some examples, when the first request indicates a QoS requirement, the QoS requirement is used for the access network element to perform QoS parameter conversion on the sent sensing reference signal. The QoS parameter is for example used to indicate a priority level, a delay level and/or a reliability level, etc.

In some examples, the sensing reference signal configuration is used to indicate at least one of:
a sensing target type to which the sensing reference signal is applied;
a sensing function or a sensing scenario to which the sensing reference signal is applied; or
resource indication information for sending the sensing reference signal.

In some examples, the sensing network element may send the first request to an access network element within a target sensing area. Here, the target sensing area may be a target area that needs to be sensed. For example, the target sensing area is determined according to a sensing requirement.

The sensing network element may obtain area information of the target sensing area, and send the first request to the access network element within the target sensing area according to the area information of the target sensing area, so as to indicate the access network element to perform sending of the sensing reference signal.

In some examples, the first request may be further used to indicate the access network element to receive the sensing reference signal.

In some examples, the first request may be further used to indicate the access network element to determine the sensing reference signal.

In some examples, in a case that the first request indicates the access network element to receive the sensing reference signal, the first request is further used to indicate acquisition of a sensing measurement result of the access network element on the received sensing reference signal.

In the information transmission method provided by the embodiments of the present disclosure, the sensing network element sends the first request to the access network element. The first request is used to indicate the access network element to send the sensing reference signal. In this way, the access network element can perform sending of the sensing reference signal in accordance with the first request sent by the sensing network element, thereby improving the sensing procedure initiated by the sensing network element towards the access network element.

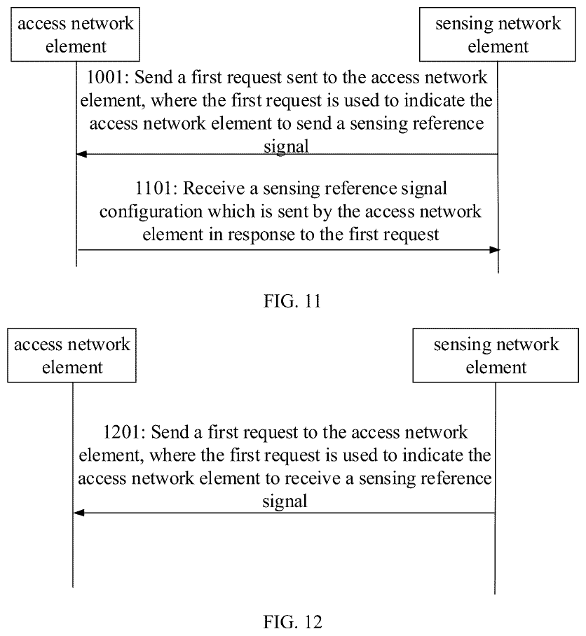

In an embodiment, as shown in FIG. 11, based on FIG. 10, the method further includes the following step:

In 1101, a sensing reference signal configuration sent by the access network element in response to the first request is received.

In this embodiment, when the first request indicates the access network element to send the sensing reference signal configuration to the sensing network element, the sensing network element can receive the sensing reference signal configuration sent by the access network element in response to the first request. Thus, the sensing network element can obtain a configuration for the access network element to send the sensing reference signal.

An embodiment of the present disclosure provides an information transmission method. The method is performed by a sensing network element. As shown in FIG. 12, the method includes the following step:

In 1201, a first request is sent to an access network element. The first request is used to indicate the access network element to receive a sensing reference signal.

In some examples, the access network element may be a base station, which may be an LTE eNB, or an NR gNB, or an ng-eNB, or an en-gNB, or other evolved base station(s).

For example, taking a base station as an example, in a case that the base station supports a base station self-transmission and self-reception sensing mode, the sensing reference signal sent by the base station can be received by the base station. In a case that the base station supports a sensing mode based on transmission and reception between base stations, the sensing reference signal sent by the base station can be received by other base station(s) than the base station.

In some examples, the first request may be sent by the sensing network element according to capability information of the access network element.

The capability information of the access network element is used to indicate a sensing capability of the access network element, for example, indicating a sending capability and/or a receiving capability of the access network element for the sensing reference signal.

In some examples, the capability information of the access network element indicates that the access network element has full-duplex capability.

In some examples, before sending the first request to the access network element, the method may further include:
receiving the capability information of the access network element, wherein the capability information is used to indicate the sensing capability of the access network element.

In some examples, in a case that the first request indicates the access network element to receive the sensing reference signal, the first request is further used to indicate acquisition of a sensing measurement result of the access network element on the received sensing reference signal.

In an embodiment, the first request is further used to indicate at least one of:
a sensing reference signal configuration for the access network element to receive the sensing reference signal;
the type of a target that needs to be sensed;
the maximum number of targets that needs to be sensed;
a sensing function or a sensing scenario that needs to be sensed;
a measurement quantity of the sensing reference signal that needs to be measured;
a sensing result that needs to be calculated;
a sensing range, a carrier frequency and/or accuracy required for sensing.

In some examples, the sensing target type is used to indicate a target to which the sensing reference signal is applied. The target may be a mobile target, such as a vehicle, a person, or a terminal, etc., or the target may be a stationary target.

For example, the type of the target that needs to be sensed may be a vehicle. That is, if sensing of a vehicle is requested, the access network element is required to perform a vehicle-related sensing measurement on the received sensing reference signal, and report a sensing measurement result with the vehicle as the target.

In some examples, the maximum number of targets that need to be sensed may be used to indicate reporting sensing measurement result(s) in which the number of targets is less than or equal to the maximum number of targets.

In some examples, the sensing scenario that needs to be sensed may be used to refer to a specific application scenario of a sensing measurement performed by the access network element, such as weather monitoring, in which case the access network element needs to report a measurement result related to weather monitoring.

As an example, the sensing function that needs to be sensed may be used to indicate a function of a UE to which the sensing measurement of the sensing reference signal is applied. For example, if the function is fitness monitoring, the access network element is required to report a fitness monitoring-related measurement result. In some examples, the measurement quantity of the sensing reference signal may include: a signal strength, a delay, a phase change, and/or a Doppler frequency shift, etc.

In some examples, the sensing result that needs to be calculated may be, for example, a position, a speed, and/or an angle of a sensing target that needs to be calculated.

As an example, the sensing result that needs to be calculated may include at least one of:
a moving speed of a target, a position of the target relative to an access network element that sends the sensing reference signal, a distance between the target and the access network element that sends the sensing reference signal, an angle between the target and the access network element that sends the sensing reference signal, a position of the target relative to an access network element that receives the sensing reference signal, a distance between the target and the access network element that receives the sensing reference signal, or an angle between the target and the access network element that receives the sensing reference signal.

In an embodiment, the sensing reference signal configuration is used to indicate at least one of:
a sensing target type to which the sensing reference signal is applied;
a sensing function or a sensing scenario to which the sensing reference signal is applied;
resource indication information for receiving the sensing reference signal.

In some examples, the first request may be further used to indicate the access network element to send the sensing reference signal.

In some examples, the sensing network element may send the first request to an access network element within a target sensing area. Here, the target sensing area may be a target area that needs to be sensed. For example, the target sensing area is determined according to a sensing requirement.

The sensing network element may obtain area information of the target sensing area, and send the first request to the access network element within the target sensing area according to the area information of the target sensing area, so as to indicate the access network element to perform reception of the sensing reference signal.

In the information transmission method provided by embodiments of the present disclosure, the access network element receives the first request sent by the sensing network element. The first request is used to indicate the access network element to receive the sensing reference signal. In this way, the access network element can perform reception of the sensing reference signal in accordance with the first request sent by the sensing network element, thereby improving the sensing procedure initiated by the sensing network element towards the access network element.

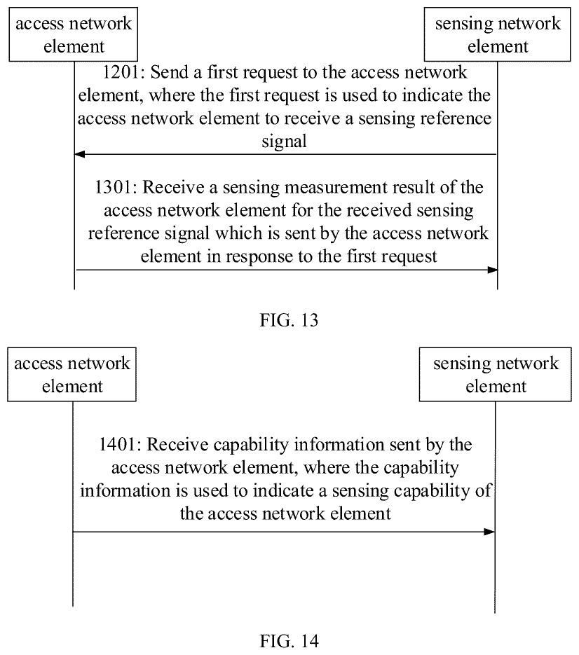

In an embodiment, as shown in FIG. 13, based on FIG. 12, the method further includes the following step:

In 1301, a sensing measurement result of the access network element for a received sensing reference signal which is sent by the access network element in response to the first request is received.

In some examples, the sensing measurement result may include: a measurement result of the sensing reference signal and/or a sensing result.

In some examples, the sensing measurement result may include: a measurement result of the sensing reference signal applied to a target type, or a target sensing function, or a target sensing scenario.

In some examples, the sensing reference signal measurement result may include, but is not limited to: a measurement value such as a signal strength of the sensing reference signal, a delay, a phase change, and/or a Doppler frequency shift, etc.

In some examples, the sensing result may include: a sensing result applied to a target type, or a target sensing function, or a target sensing scenario.

In some examples, the sensing result applied to the target type may include, but is not limited to: a moving speed of the target, a position of the target relative to the base station, a distance between the target and the base station, and/or an angle between the target and the base station.

In some examples, the sensing result applied to the target sensing function may include, but is not limited to: a respiratory monitoring result, an invasion monitoring result, a fitness monitoring results, and/or a posture recognition result, etc.

In some examples, the sensing result applied to the target sensing scenario may include, but is not limited to: a weather monitoring result, a pedestrian flow statistics result, a traffic monitoring result, and/or a channel environment sensing result, etc.

In some examples, the sensing measurement result may include: sensing signal measurement results and/or sensing results of all targets that can be sensed by the access network element.

In an embodiment, the sensing network element may receive the sensing measurement result sent by the access network element in response to the first request.

In an embodiment, the sensing measurement result includes at least one of:
a sensing reference signal measurement result and/or a sensing result of a sensing target for a target type requested for sensing;
a sensing reference signal measurement result and/or a sensing result of a sensing target corresponding to a requested sensing function or sensing scenario;
a sensing reference signal measurement result and/or a sensing result of a sensing target not exceeding a maximum number of targets requested for sensing;
a target type associated with the sensing reference signal measurement result and/or the sensing result of the sensing target.

In some examples, the sensing reference signal measurement result may include: a result obtained by measuring the sensing reference signal based on a measurement quantity. For example, the measurement quantity may include information such as signal strength, a delay, a phase change, and/or a Doppler frequency shift, etc.

The sensing result of the sensing target may include a result obtained by performing processing based on the measurement result of the sensing reference signal. For example, the sensing result may include the size, position, and/or speed of a target, etc. The processing may include superimposing, fusing, and/or analyzing the measurement result(s) of the sensing reference signal, etc.

As an example, the target type associated with the sensing reference signal measurement result and/or the sensing result may be used to characterize a target associated with the sensing measurement performed by the access network element on the received sensing reference signal. For example, if the access network element performs a vehicle-related sensing measurement on the received sensing reference signal to obtain a sensing measurement result, the target type associated with the sensing measurement result is a vehicle.

As an example, the sensing scenario associated with the sensing reference signal measurement result and/or the sensing result of the sensing target may be used to characterize a scenario to which the sensing measurement performed by the access network element on the received sensing reference signal is applied. For example, the scenario is: weather monitoring, environmental monitoring, or pedestrian flow statistics, etc.

An embodiment of the present disclosure provides an information transmission method. The method is performed by a sensing network element. As shown in FIG. 14, the method includes the following step:

In 1401, capability information sent by an access network element is received. The capability information is used to indicate a sensing capability of the access network element.

The capability information is used to indicate at least one of:
a self-transmission and self-reception capability of the access network element;
a full duplex capability of the access network element;
a processing capability of the access network element for a received sensing reference signal;
a target type supported to be sensed by the access network element;
a sensing function or a sensing scenario supported by the access network element;
a measurement quantity of the access network element for the received sensing reference signal;
a sensing result supported to be calculated by the access network element.

In some examples, the self-transmission and self-reception capability of the access network element is used to determine whether the access network element supports a self-transmission and self-reception sensing mode of the access network element.

In some examples, the full-duplex capability of an access network element is used to determine whether the access network element supports a sensing mode based on transmission and reception between access network elements.

In some examples, the processing capability of the access network element for the received sensing reference signal is used to indicate at least one of:
the maximum number of targets supported to be sensed simultaneously, which may be for example, the number of targets that can be recognized by receiving a sensing reference signal once;
the maximum distance at which sensing of a target is supported; for example, if the maximum distance of the target is exceeded, the target cannot be sensed.

In some examples, the sensing function or sensing scenario may be, for example, weather monitoring, respiratory monitoring, invasion monitoring, fitness monitoring, gesture/posture recognition, and/or traffic monitoring.

In some examples, the measurement quantity of the sensing reference signal may include: a signal strength, a delay, a phase change and/or a Doppler frequency shift, etc.

In some examples, the sensing result supported to be calculated may be for example whether the position, speed and/or angle of the sensing target are supported to be calculated.

As an example, the sensing result may include at least one of:
a moving speed of a target, a position of the target relative to an access network element that sends the sensing reference signal, a distance between the target and the access network element that sends the sensing reference signal, an angle between the target and the access network element that sends the sensing reference signal, a position of the target relative to an access network element that receives the sensing reference signal, a distance between the target and the access network element that receives the sensing reference signal, or an angle between the target and the access network element that receives the sensing reference signal.

In some examples, the capability information of the access network element may be actively reported (e.g., periodically reported) by the access network element to the sensing network element. The sensing network element may store the capability information of the access network element.

In other examples, the sensing network element may send a sensing capability request to the access network element, requesting the access network element to send the capability information of the access network element to the sensing network element.

In some examples, the method may further include:
receiving capability update information sent by the access network element, wherein the capability update information is used to update the capability information of the access network element.

The sensing capability(capabilities) supported by the access network element may change. For example, the access network element may add sensing capability(capabilities) that needs(need) to be supported or reduce sensing capabilities that are already supported.

In some examples, the capability update information may indicate an added sensing capability or a reduced sensing capability of the access network element, or the capability update message may indicate updated sensing capability(capabilities) of the access network element.

In the embodiments, the sensing network element receives the capability information of the access network element, so that the sensing network element can initiate a sensing procedure towards the access network element using the capability information of the access network element, thereby ensuring the effectiveness of initiating of the sensing procedure.

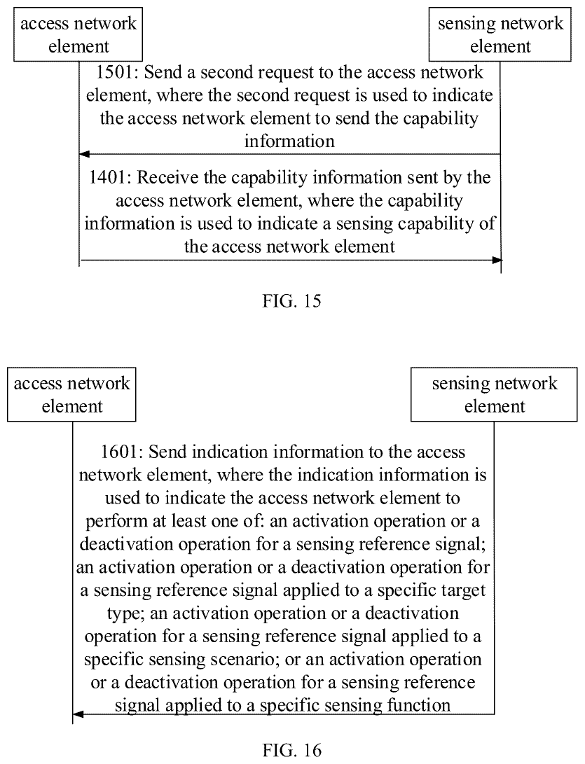

In an embodiment, as shown in FIG. 15, based on FIG. 14, the method further includes the following step:

In 1501, a second request is sent to an access network element. The second request is used to indicate the access network element to send the capability information.

In some examples, the sensing network element may obtain area information of a target sensing area, and send the second request to all access network elements within the target sensing area based on the area information of the target sensing area, to indicate the access network elements within the target sensing area to send the capability information.

In the embodiment, the sensing network element may request obtaining of the capability information of the access network element from the access network element.

An embodiment of the present disclosure provides an information transmission method. The method is performed by a sensing network element. As shown in FIG. 16, the method includes the following step:

In 1601, indication information is sent to an access network element. The indication information is used to indicate the access network element to perform one of:
an activation operation or a deactivation operation for a sensing reference signal;
an activation operation or a deactivation operation for a sensing reference signal applied to a specific target type;
an activation operation or a deactivation operation for a sensing reference signal applied to a specific sensing scenario;
an activation operation or a deactivation operation for a sensing reference signal applied to a specific sensing function.

In some examples, when the indication information indicates the access network element to perform an activation operation, the indication information may include an identity of the sensing reference signal to be activated. Furthermore, the indication information may further include identity information of a specific target type, a specific sensing scenario, and/or a specific sensing function, to indicate the access network element to perform the activation operation for a specific sensing reference signal.

In some examples, when the indication information indicates the access network element to perform a deactivation operation, the indication information may include an identity of the sensing reference signal to be deactivated. In addition, the indication information may also include a specific target type, a specific sensing scenario.

Here, an activation operation for a sensing reference signal refers to enabling (or starting) transmission and reception of the sensing reference signal.

Here, a deactivation operation for a sensing reference signal refers to disabling (or forbidding) transmission and reception of the sensing reference signal.

As an example, the indication information may be used to indicate the access network element to perform an activation operation for a sensing reference signal after a specified time, or to indicate the access network element to reactivate a sensing reference signal that has been deactivated before.

As an example, the indication information may be used to indicate the access network element to perform a deactivation operation for a sensing reference signal after a specified time, or to indicate the access network element to deactivate a sensing reference signal that has been activated before.

The specific target type may be any specified target type, such as a vehicle or a pedestrian. Compared to the transmission period and/or reception period of a sensing reference signal applied to a pedestrian, the transmission period and/or reception period of a sensing reference signal applied to a vehicle is shorter.

For example, if the indication information indicates the access network element to perform an activation operation for a sensing reference signal applied to a vehicle, the access network element may send and/or receive the activated sensing reference signal applied to the vehicle after performing the corresponding activation operation.

For example, if the indication information indicates the access network element to perform a deactivation operation for a sensing reference signal applied to a pedestrian, after the access network element performs the corresponding deactivation operation, the access network element cannot send and receive the deactivated sensing reference signal applied to the pedestrian.

The specific sensing scenario mentioned above may be any specified target sensing scenario, such as weather monitoring or invasion monitoring, etc. The specific sensing function mentioned above may be any specified target sensing function, such as channel environment sensing, etc.

In the embodiment, the access network element may perform the operation (activating or deactivating a corresponding sensing reference signal) indicated by the indication information sent by the sensing network element. In this way, flexible control over the sending or receiving of the sensing reference signal by the access network element can be achieved.

Any embodiment of the present disclosure may be arbitrarily combined with other embodiment(s) if such combination does not result in contradiction; any solution (or optional solution) in any embodiment of the present disclosure may be combined with each other if such combination does not result in contradiction; any solution in any embodiment of the present disclosure may be combined with any solution in other embodiment(s) if such combination does not result in contradiction. The step(s) in any embodiment of the present disclosure may be interchanged in order if no contradiction occurs.

It should be noted that those skilled in the art can understand that the methods provided in the embodiments of the present disclosure may be performed independently or may be performed together with some methods in the embodiments of the present disclosure or some methods in related art.

In order to further explain any one of the embodiments of the present disclosure, several specific embodiments are provided below.

An embodiment of the present disclosure provides an information transmission method, which can realize sensing based on base station self-transmission and self-reception or sensing based on transmission and reception between base stations.

An embodiment of the present disclosure provides an information transmission method. The method may include at least one of the following steps:
requesting, by a sensing network element, a base station to send a sensing capability;
requesting, by the sensing network element, the base station to send a sensing reference signal;
requesting, by the sensing network element, the base station to send a sensing reference signal measurement result;
requesting, by the sensing network element, the base station to activate or deactivate a sensing reference signal configuration.

In some examples, requesting, by the sensing network element, the base station to send the sensing capability, includes requesting the following base station to send the following sensing capability(capabilities):
a self-transmission and self-reception capability for the sensing signal;
a full-duplex capability;
a capability for processing the sensing signal;
the maximum number of targets supported to be sensed simultaneously, for example, the number of targets that can be recognized by receiving a single sensing signal once;
the maximum distance at which sensing of a target is supported; for example, if the maximum distance of the target is exceeded, the target cannot be sensed;
a supported recognition capability for sensing a target or a target type that can be sensed, such as being able to recognize a target type which is a moving target, a stationary target, a vehicle, people, a terminal, an object, or being able to sense a certain target type or multiple target types;
a supported sensing function or sensing scenario; for example, weather monitoring, respiratory monitoring, invasion detection, fitness monitoring, gesture/posture recognition, or traffic monitoring.

In some examples, based on the request of the sensing network element, the base station sends the above capability(capabilities) to the sensing network element, such as at least one of the following:
supporting of the self-transmission and self-reception of the sensing signal;
supporting of the full-duplex;
supported processing capability(capabilities), such as the supported maximum number of targets that can be sensed simultaneously, the supported maximum distance at which a target can be sensed;
a target type supported to be sensed;
a supported sensing function or sensing scenario.

In some examples, requesting, by the sensing network element, the base station to send the sensing reference signal, includes indicating to the base station at least one of the following:
a sensing reference signal configuration recommended by the sensing network element;
the sensing network element indicating the base station whether to send a sensing reference signal configuration determined by the base station to the sensing network element;
the type of target being sensed, such as a vehicle, or a person, or an object;
an application scenario of sensing;
a QOS requirement of sensing.

In some examples, different sensing reference signal configurations may be applied to different target types.

In some examples, the base station determines the sensing reference signal configuration and determines, based on a request from the sensing network element, to send the sensing reference signal to the sensing network element, and indicates at least one of the following:
a sensing target type to which the sensing reference signal is applied;
a sensing scenario or sensing function to which the sensing reference signal is applied.

In some examples, requesting, by the sensing network element, the base station to send the sensing reference signal measurement result, includes requesting at least one of the following:
a sensing reference signal configuration;
a sensing target type; for example, if a vehicle is requested to be sensed, the base station only reports a sensing measurement result with the vehicle as the target;
the maximum number of targets that needs to be sensed;
a sensing function, indicating the sensing function to be performed; for example, for weather monitoring, the base station only reports a measurement result related to weather monitoring, and the base station does not need to report sensing result(s) for a target which is a vehicle, a person or a fixed object.
a sensing signal measurement result;
a sensing result of the sensing target, such as, a moving speed of the target, a position of the target relative to the base station, a distance between the target and the base station, an angle between the target and the base station.

In some examples, sending, by the base station, the measurement result to the sensing network element according to the request of the sensing network element includes:
measuring the sensing reference signal and sending one of the following to the sensing network element:
a sensing signal measurement result and/or a sensing result of a sensing target for the requested target type;
a sensing signal measurement result and/or a sensing result of a sensing target for a requested sensing function;
reporting sensing signal measurement result(s) and/or sensing result(s) of sensing target(s) not exceeding the maximum number requested by the sensing network element;
reporting sensing signal measurement result(s) and/or sensing result(s) of sensing target(s) for all targets sensed by the base station;
indicating a target type associated with a sensing signal measurement result and/or a sensing result of a sensing target.

In some examples, requesting, by the sensing network element, the base station to activate or deactivate the sensing reference signal configuration includes indicating, to the base station, one of the following:
an activation operation or a deactivation operation for a sensing reference signal;
an activation operation or a deactivation operation for a sensing reference signal applied to a specific target type;
an activation operation or a deactivation operation for a sensing reference signal applied to a specific sensing scenario;
an activation operation or a deactivation operation for a sensing reference signal applied to a specific sensing function.

In some examples, the base station activates or deactivates the sensing reference signal according to the request of the sensing network element.

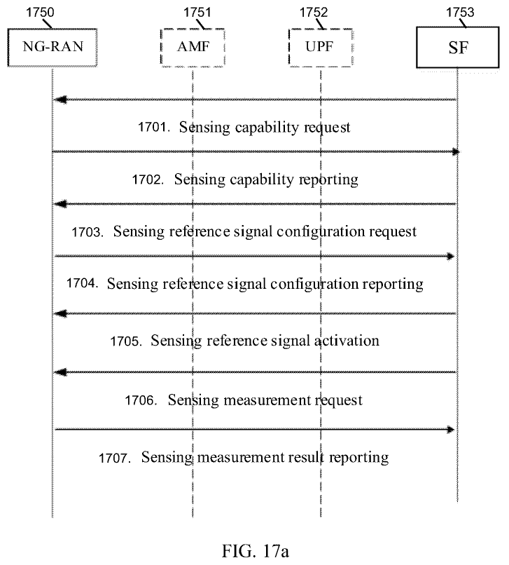

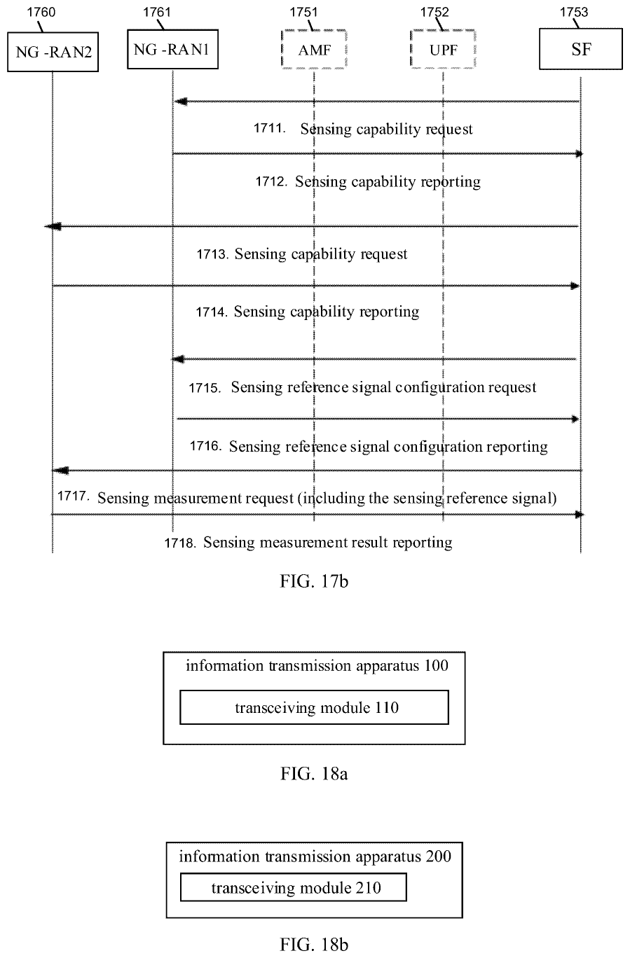

As shown in FIG. 17a, an embodiment of the present disclosure provides an information transmission method for realizing sensing based on base station self-transmission and self-reception. Note that an AMF 1751 and UPF 1752 are shown but not involved in the steps described. The method may include the following steps:
1701. An SF 1753 sends a sensing capability request to a base station (e.g., NG-RAN 1750).

In this embodiment, the base station supports a sensing mode based on base station self-transmission and self-reception.

The sensing capability request is used to indicate the base station to report a sensing capability to the SF (the sensing capability may be the capability information in the aforementioned embodiments).
1702. The base station reports the sensing capability to the SF.
1703. The SF sends a sensing reference signal configuration request to the base station.

The sensing reference signal configuration request is used to indicate the base station to report a sensing reference signal configuration.
1704. The base station reports the sensing reference signal configuration to the SF.
1705. The SF sends an indication for activating a sensing reference signal to the base station.

The indication for activating the sensing reference signal is used to indicate the base station to activate the sensing reference signal.

In a case that the base station activates the sensing reference signal, the base station may send the sensing reference signal, receive the sensing reference signal sent by itself, and perform a sensing measurement on the received sensing reference signal.
1706. The SF sends a sensing measurement request to the base station.

The sensing measurement request is used to indicate obtaining of the sensing measurement result of the base station for the received sensing reference signal.

As an example, the SF may send the sensing measurement request to the base station according to the sensing capability of the base station.
1707. The base station reports the sensing measurement result to the SF.

As an example, the sensing measurement result may include a measurement result and/or a sensing result of the base station for the received sensing reference signal. The sensing result is obtained through calculation of the measurement result by the base station.

It can be understood that, in the absence of contradiction, each of the above steps 1701 to 1707 in this embodiment can be used as a separate embodiment, or may be combined with each other or the execution order can be exchanged.

As shown in FIG. 17b, an embodiment of the present disclosure provides an information transmission method for realizing sensing based on transmission and reception between base stations. The method may include the following steps:
1711. A SF 1753 sends a sensing capability request to a first base station (for example, NG-RAN1 1761).

In this embodiment, the first base station and a second base station (for example, NG-RAN2) support the sensing mode based on transmission and reception between base stations, and the second base station can receive a sensing reference signal sent by the first base station.

The sensing capability request is used to indicate the first base station to report the sensing capability to the SF (the sensing capability may be the capability information in the aforementioned embodiments).
1712. The first base station reports the sensing capability of the first base station to the SF.
1713. The SF sends a sensing capability request to the second base station.

The sensing capability request is used to indicate the second base station to report the sensing capability to the SF (the sensing capability may be the capability information in the aforementioned embodiments).
1714. The second base station reports the sensing capability of the second base station to the SF.
1715. The SF sends a sensing reference signal configuration request to the first base station.

The sensing reference signal configuration request is used to indicate the first base station to report a sensing reference signal configuration.
1716. The first base station reports the sensing reference signal configuration to the SF.
1717. The SF sends a sensing measurement request to the second base station 1760.

The sensing measurement request is used to indicate the second base station to receive a sensing measurement signal and indicate obtaining of a sensing measurement result of the second base station for the received sensing reference signal.

As an example, the SF may send the sensing measurement request to the second base station according to the sensing capability of the second base station.
1718. The second base station reports the sensing measurement result to the SF.

As an example, the sensing measurement result may include a measurement result and/or a sensing result of the received sensing reference signal by the second base station. The sensing result is obtained through calculation of the measurement result by the second base station.

It can be understood that, in the absence of contradiction, each of the above steps 1711 to 1718 in this embodiment can be used as a separate embodiment, or can be combined with each other or the execution order can be exchanged.

Any embodiment of the present disclosure may be arbitrarily combined with other embodiment(s) if such combination does not result in contradiction; any solution (or optional solution) in any embodiment of the present disclosure may be combined with each other if such combination does not result in contradiction; any solution in any embodiment of the present disclosure may be combined with any solution in other embodiment(s) if such combination does not result in contradiction. The step(s) in any embodiment of the present disclosure may be interchanged in order if no contradiction occurs.

It should be noted that those skilled in the art will understand that the methods provided in the embodiments of the present disclosure may be performed independently or may be performed together with some methods in the embodiments of the present disclosure or some methods in related art.

FIG. 18a is a structural diagram of an information transmission apparatus according to an example embodiment. The information transmission apparatus is applied to an access network element. As shown in FIG. 18a, the information transmission apparatus 100 includes:
a transceiving module 110 configured to receive a first request sent by a sensing network element, wherein the first request is used to indicate the access network element to send a sensing reference signal or to receive the sensing reference signal.

In an embodiment, the transceiving module 110 is configured to:
send capability information of the access network element to the sensing network element;
wherein the capability information is used to indicate at least one of:
a self-transmission and self-reception capability of the access network element;
a full duplex capability of the access network element;
a processing capability of the access network element for a received sensing reference signal;
a target type supported to be sensed by the access network element;
a sensing function or a sensing scenario supported by the access network element;
a measurement quantity of the access network element for the received sensing reference signal by; or
a sensing result supported to be calculated by the access network element.

In an embodiment, the transceiver module 110 is configured to:
receive a second request sent by the sensing network element, wherein the second request is used to indicate the access network element to send the capability information.

In an embodiment, when the first request is used to indicate the access network element to send the sensing reference signal, the first request is further used to indicate at least one of:
configuration information recommended by the sensing network element, wherein the recommended configuration information is used for the access network element to determine a sensing reference signal configuration;
requesting the access network element to send the sensing reference signal configuration to the sensing network element;
a sensing target type;
a sensing function or a sensing scenario of sensing; or
a Quality of Service (QOS) requirement.

In an embodiment, the trasnceiving module 110 is configured to:
in response to the first request, send the sensing reference signal configuration to the sensing network element.

In an embodiment, when the first request is used to indicate the access network element to receive the sensing reference signal, the first request is further used to indicate at least one of:
a sensing reference signal configuration for the access network element to receive the sensing reference signal;
a target type that needs to be sensed;
a maximum number of targets that need to be sensed;
a sensing function or a sensing scenario that needs to be sensed;
a measurement quantity of the sensing reference signal that needs to be measured; or
a sensing result that needs to be calculated.

In an embodiment, the sensing reference signal configuration is further used to indicate at least one of:
a sensing target type to which the sensing reference signal is applied; or
a sensing function or a sensing scenario to which the sensing reference signal is applied.

In an embodiment, the transceiving module 110 is configured to:
in response to the first request, send, to the sensing network element, a sensing measurement result of a received sensing reference signal by the access network element.

In an embodiment, the sensing measurement result includes at least one of:
a sensing reference signal measurement result and/or a sensing result of a sensing target for a target type requested for sensing;
a sensing reference signal measurement result and/or a sensing result of a sensing target corresponding to a requested sensing function or sensing scenario;
a sensing reference signal measurement result and/or a sensing result of a sensing target not exceeding a maximum number of targets requested for sensing; or
a target type associated with the sensing reference signal measurement result and/or the sensing result of the sensing target.

In an embodiment, the transceiving module 110 is configured to:
receive indication information sent by the sensing network element, wherein the indication information is used to indicate the access network element to perform one of:
an activation operation or a deactivation operation for a sensing reference signal;
an activation operation or a deactivation operation for a sensing reference signal applied to a specific target type;
an activation operation or a deactivation operation for a sensing reference signal applied to a specific sensing scenario; or
an activation operation or a deactivation operation for a sensing reference signal applied to a specific sensing function.

Regarding the information transmission apparatus in the above embodiments, the specific manner in which each module performs operation(s) has been described in detail in the embodiments of the information transmission method performed by the first UE, and will not be elaborated here.

It should be noted that those skilled in the art can understand that the information transmission apparatus provided in any embodiment of the present disclosure may be implemented independently or together with some apparatuses in other embodiments of the present disclosure or some apparatuses in related art.

FIG. 18b is a structural diagram of an information transmission apparatus according to an example embodiment. The information transmission apparatus is applied to a sensing network element. As shown in FIG. 18b, the information transmission apparatus 200 includes:
a transceiving module 210 configured to send a first request to an access network element, wherein the first request is used to indicate the access network element to send a sensing reference signal or to receive a sensing reference signal.

In an embodiment, the transceiving module 210 is configured to:
receive capability information sent by the access network element, wherein the capability information is used to indicate at least one of:
a self-transmission and self-reception capability of the access network element;
a full duplex capability of the access network element;
a processing capability of the access network element for a received sensing reference signal;
a target type supported to be sensed by the access network element;
a sensing function or a sensing scenario supported by the access network element;
a measurement quantity of the access network element for the received sensing reference signal; or
a sensing result supported to be calculated by the access network element.

In an embodiment, the transceiving module 210 is configured to:
send a second request to the access network element, wherein the second request is used to indicate the access network element to send the capability information.

In an embodiment, when the first request is used to indicate the access network element to send the sensing reference signal, the first request is further used to indicate at least one of:
configuration information recommended by the sensing network element, wherein the recommended configuration information is used for the access network element to determine a sensing reference signal configuration;
requesting the access network element to send the sensing reference signal configuration to the sensing network element;
a sensing target type;
a sensing function or a sensing scenario of sensing; or
a Quality of Service (QoS) requirement.

In an embodiment, the transceiving module 210 is configured to:
receive the sensing reference signal configuration which is sent by the access network element in response to the first request.

In an embodiment, when the first request is used to indicate the access network element to receive the sensing reference signal, the first request is further used to indicate at least one of:
a sensing reference signal configuration for the access network element to receive the sensing reference signal;
a target type that needs to be sensed;
a maximum number of targets that need to be sensed;
a sensing function or a sensing scenario that needs to be sensed;
a measurement quantity of the sensing reference signal that needs to be measured; or
a sensing result that needs to be calculated.

In an embodiment, the sensing reference signal configuration is further used to indicate at least one of:
a sensing target type to which the sensing reference signal is applied; or
a sensing function or a sensing scenario to which the sensing reference signal is applied.

In an embodiment, the transceiving module 210 is configured to:
receive a sensing measurement result of a received sensing reference signal by the access network element, which is sent by the access network element in response to the first request.

In an embodiment, the sensing measurement result includes at least one of:
a sensing reference signal measurement result and/or a sensing result of a sensing target for a target type requested for sensing;
a sensing reference signal measurement result and/or a sensing result of a sensing target corresponding to a requested sensing function or sensing scenario;
a sensing reference signal measurement result and/or a sensing result of a sensing target not exceeding a maximum number of targets requested for sensing; or
a target type associated with the sensing reference signal measurement result and/or the sensing result of the sensing target.

In an embodiment, the transceiving module 210 is configured to:
send indication information to the access network element, wherein the indication information is used to indicate the access network element to perform one of:
an activation operation or a deactivation operation for a sensing reference signal;
an activation operation or a deactivation operation for a sensing reference signal applied to a specific target type;
an activation operation or a deactivation operation for a sensing reference signal applied to a specific sensing scenario; or
an activation operation or a deactivation operation for a sensing reference signal applied to a specific sensing function.

Regarding the information transmission apparatus in the above embodiments, the specific manner in which each module performs operation(s) has been described in detail in the embodiments of the information transmission methods performed by the second UE, and will not be elaborated here.

It should be noted that those skilled in the art can understand that the information transmission apparatus provided in any embodiment of the present disclosure may be implemented independently or together with some apparatuses in other embodiments of the present disclosure or some apparatuses in related art.

An embodiment of the present disclosure provides a communication system. The communication system includes:
a sensing network element configured to send a first request to an access network element, wherein the first request is used to indicate the access network element to send a sensing reference signal or to receive the sensing reference signal; and
the access network element configured to receive the first request sent by the sensing network element.

In an embodiment, the access network element is configured to:
send capability information of the access network element to the sensing network element;
wherein the capability information is used to indicate at least one of:
a self-transmission and self-reception capability of the access network element;
a full duplex capability of the access network element;
a processing capability of the access network element for a received sensing reference signal;
a target type supported to be sensed by the access network element;
a sensing function or a sensing scenario supported by the access network element;
a measurement quantity of the access network element for the received sensing reference signal; or
a sensing result supported to be calculated by the access network element.

In an embodiment, the access network element is configured to:
receiving a second request sent by the sensing network element, wherein the second request is used to indicate the access network element to send the capability information.

In an embodiment, when the first request is used to indicate the access network element to send the sensing reference signal, the first request is further used to indicate at least one of:
configuration information recommended by the sensing network element, wherein the recommended configuration information is used for the access network element to determine a sensing reference signal configuration;
requesting the access network element to send the sensing reference signal configuration to the sensing network element;
a sensing target type;
a sensing function or a sensing scenario of sensing; or
a Quality of Service (QoS) requirement.

In an embodiment, the access network element is configured to:
in response to the first request, send the sensing reference signal configuration to the sensing network element.

In an embodiment, when the first request is used to indicate the access network element to receive the sensing reference signal, the first request is further used to indicate at least one of:
a sensing reference signal configuration for the access network element to receive the sensing reference signal;
a target type that needs to be sensed;
a maximum number of targets that need to be sensed;
a sensing function or a sensing scenario that needs to be sensed;
a measurement quantity of the sensing reference signal that needs to be measured; or
a sensing result that needs to be calculated.

In an embodiment, the sensing reference signal configuration is further used to indicate at least one of:
a sensing target type to which the sensing reference signal is applied; or
a sensing function or a sensing scenario to which the sensing reference signal is applied.

In an embodiment, the access network element is configured to:
in response to the first request, send, to the sensing network element, a sensing measurement result of a received sensing reference signal by the access network element.

In an embodiment, the sensing measurement result includes at least one of:
a sensing reference signal measurement result and/or a sensing result of a sensing target for a target type requested for sensing;
a sensing reference signal measurement result and/or a sensing result of a sensing target corresponding to a requested sensing function or sensing scenario;
a sensing reference signal measurement result and/or a sensing result of a sensing target not exceeding a maximum number of targets requested for sensing; or
a target type associated with the sensing reference signal measurement result and/or the sensing result of the sensing target.

In an embodiment, the access network element is configured to:
receive indication information sent by the sensing network element, wherein the indication information is used to indicate the access network element to perform one of:
an activation operation or a deactivation operation for a sensing reference signal;
an activation operation or a deactivation operation for a sensing reference signal applied to a specific target type;
an activation operation or a deactivation operation for a sensing reference signal applied to a specific sensing scenario; or
an activation operation or a deactivation operation for a sensing reference signal applied to a specific sensing function.

In an embodiment, the sensing network element is configured to:
receive capability information sent by the access network element, wherein the capability information is used to indicate at least one of:
a self-transmission and self-reception capability of the access network element;
a full duplex capability of the access network element;
a processing capability of the access network element for a received sensing reference signal;
a target type supported to be sensed by the access network element;
a sensing function or a sensing scenario supported by the access network element;
a measurement quantity of the access network element for the received sensing reference signal; or
a sensing result supported to be calculated by the access network element.

In an embodiment, the sensing network element is configured to:
send a second request to the access network element, wherein the second request is used to indicate the access network element to send the capability information.

In an embodiment, the sensing network element is configured to:
receive the sensing reference signal configuration which is sent by the access network element in response to the first request.

In an embodiment, the sensing network element is configured to:
receive a sensing measurement result of a received sensing reference signal by the access network element, which is sent by the access network element in response to the first request.

In an embodiment, the sensing network element is configured to:
send indication information to the access network element, wherein the indication information is used to indicate the access network element to perform one of:
an activation operation or a deactivation operation for a sensing reference signal;
an activation operation or a deactivation operation for a sensing reference signal applied to a specific target type;
an activation operation or a deactivation operation for a sensing reference signal applied to a specific sensing scenario; or
an activation operation or a deactivation operation for a sensing reference signal applied to a specific sensing function.

For details of the above implementations, reference may be made to the relevant descriptions at the first UE side, the second UE side and/or the network device side, which will not be repeated here.

An embodiment of the present disclosure provides a communication device, including a processor, a memory, and an executable program stored in the memory and capable of being run by the processor. When the processor runs the executable program, the information transmission method provided by any of the aforementioned technical solutions is implemented.

The processor may include various types of storage medium, which may be non-transitory computer storage medium that can continue to memorize information stored thereon after the communication device is powered off.

Here, the communication device includes: a network device, and the network device may be a sensing network element or an access network element.

The processor may be connected to the memory via a bus or the like, and may be configured to read the executable program stored in the memory, for example, the information transmission method of any of the above embodiments.

An embodiment of the present disclosure further provides a computer storage medium storing a computer executable program. When the executable program is executed by a processor, the information transmission method of any embodiment of the present disclosure is implemented.

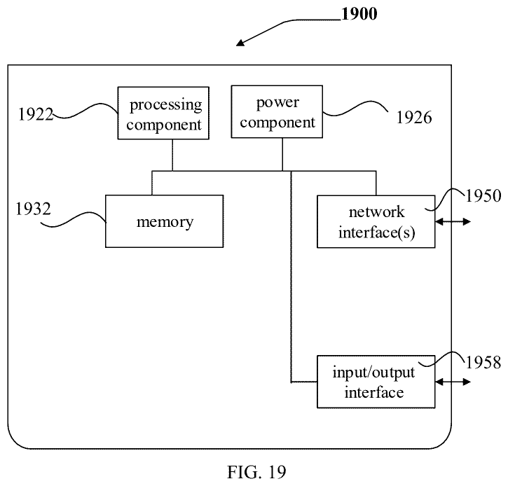

As shown in FIG. 19, an embodiment of the present disclosure shows a structure of a communication device. For example, the communication device 1900 may be provided as a network side device. The communication device may be various network elements, such as the access network element and/or sensing network element as described above.

Referring to FIG. 19, a communication device 1900 includes a processing component 1922 that further includes one or more processors, and memory resources represented by a memory 1932 for storing instructions executable by the processing component 1922, such as application programs. The application programs stored in the memory 1932 may include one or more modules each corresponding to a set of instructions. Further, the processing component 1922 is configured to execute the instructions to perform the information transmission method provided in any of the embodiments of the present disclosure.

The communication device 1900 may also include a power component 1926 configured to perform power management of the communication device 1900, wired or wireless network interface(s) 1950 configured to connect the communication device 1900 to a network, and an input/output (I/O) interface 1958. The communication device 1900 may operate based on an operating system stored in the memory 1932, such as Windows Server™, Mac OS X™, Unix™, Linux™, FreeBSD™, or the like.

In the technical solutions provided by the embodiments of the present disclosure, the access network element receives the first request sent by the sensing network element. The first request is used to indicate the access network element to send the sensing reference signal or to receive the sensing reference signal. In this way, the access network element can perform the transmission or reception of the sensing reference signal in accordance with the first request sent by the sensing network element, thereby improving the sensing procedure initiated by the sensing network element towards the access network element.

Each step in a certain implementation or embodiment may be implemented as an independent embodiment, and respective steps may be arbitrarily combined if no contradiction occurs. For example, a solution after removing a part of steps in a certain implementation or embodiment may also be implemented as an independent embodiment, and the order of respective steps in a certain implementation or embodiment may be arbitrarily exchanged. In addition, optional methods or optional examples in a certain implementation or embodiment may be arbitrarily combined. In addition, various implementations or embodiments may be arbitrarily combined. For example, a part or all steps of different implementations or embodiments may be arbitrarily combined, and a certain implementation or embodiment may be arbitrarily combined with optional method(s) or optional example(s) of other implementations or embodiments.

Other embodiments of the present disclosure will be apparent to those skilled in the art from consideration of the specification and practice of the disclosure disclosed here. The present disclosure is intended to cover any variations, uses, or adaptations of the disclosure following the general principles thereof and including such departures from the present disclosure as come within known or customary practice in the art. It is intended that the specification and examples be considered as illustrative only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. An information transmission method, performed by an access network element, and the method comprising:
receiving a first request sent by a sensing network element, wherein the first request indicates the access network element to send a sensing reference signal or to receive the sensing reference signal.

2. The method according to claim 1, further comprising:
sending capability information of the access network element to the sensing network element;
wherein the capability information indicates at least one of:
a self-transmission and self-reception capability of the access network element;
a full duplex capability of the access network element;
a processing capability of the access network element for a received sensing reference signal;
the sensing type supported by the access network element;
a sensing function or a sensing scenario supported by the access network element;
a measurement quantity of the access network element for the received sensing reference signal; or
a sensing result calculated supported by the access network element.

3. The method according to claim 2, further comprising:
receiving a second request sent by the sensing network element, wherein the second request to indicates the access network element to send the capability information.

4. The method according to claim 1, wherein in response to the first request indicating the access network element to send the sensing reference signal, the first request further indicates at least one of:
configuration information recommended by the sensing network element, wherein the configuration information recommended by the sensing network element used for the access network element to determine a sensing reference signal configuration;
requesting the access network element to send the sensing reference signal configuration to the sensing network element; the sensing type;
a sensing function or a sensing scenario of sensing; or
a Quality of Service (QoS) requirement.

5. The method according to claim 4, further comprising:
in response to the first request, sending the sensing reference signal configuration to the sensing network element.

6. The method according to claim 1, wherein in response to the first request indicating the access network element to receive the sensing reference signal, the first request further indicates at least one of:
a sensing reference signal configuration for the access network element to receive the sensing reference signal;
the type that needs to be sensed;
a maximum number that need to be sensed;
a sensing function or a sensing scenario that needs to be sensed;
a measurement quantity of the sensing reference signal that needs to be measured; or
a sensing result that needs to be calculated.

7. The method according to claim 4, wherein the sensing reference signal configuration further indicates at least one of:
the sensing type to which the sensing reference signal is applied; or
a sensing function or a sensing scenario to which the sensing reference signal is applied.

8. The method according to claim 6, further comprising:
in response to the first request, sending, to the sensing network element, a sensing measurement result of a received sensing reference signal by the access network element.

9. The method according to claim 8, wherein the sensing measurement result comprises at least one of:
at least one of a sensing reference signal measurement result or a sensing result of the sensing type requested for sensing;
at least one of a sensing reference signal measurement result or a sensing result of a sensing target corresponding to a requested sensing function or sensing scenario;
at least one of a sensing reference signal measurement result or a sensing result of the sensing number not exceeding a maximum number requested for sensing; or a sensing type associated with at least one of the sensing reference signal measurement result or the sensing result of the sensing target.

10. The method according to claim 1, further comprising:
receiving indication information sent by the sensing network element, wherein the indication information indicates the access network element to perform one of:
an activation operation or a deactivation operation for a sensing reference signal;
an activation operation or a deactivation operation for a sensing reference signal applied to the specific type;
an activation operation or a deactivation operation for a sensing reference signal applied to a specific sensing scenario; or
an activation operation or a deactivation operation for a sensing reference signal applied to a specific sensing function.

11. An information transmission method, performed by a sensing network element, and the method comprising:
sending a first request to an access network element, wherein the first request indicates the access network element to send a sensing reference signal or to receive a sensing reference signal.

12. The method according to claim 11, further comprising:
receiving capability information sent by the access network element, wherein the capability information indicates at least one of:
a self-transmission and self-reception capability of the access network element;
a full duplex capability of the access network element;
a processing capability of the access network element for a received sensing reference signal;
the sensing type supported by the access network element;
a sensing function or a sensing scenario supported by the access network element;
a measurement quantity of the access network element for the received sensing reference signal; or
a sensing result calculated supported by the access network element.

13. The method according to claim 12, wherein the method further comprises:
sending a second request to the access network element, wherein the second request indicates the access network element to send the capability information.

14. The method according to claim 11, wherein in response to the first request indicating the access network element to send the sensing reference signal, the first request further indicates at least one of:
configuration information recommended by the sensing network element, wherein the configuration information recommended by the sensing network element is for the access network element to determine a sensing reference signal configuration;
requesting the access network element to send the sensing reference signal configuration to the sensing network element;
the sensing type;
a sensing function or a sensing scenario of sensing; or
a Quality of Service (QoS) requirement.

15. The method according to claim 14, further comprising:
receiving the sensing reference signal configuration which is sent by the access network element in response to the first request.

16. The method according to claim 11, wherein in response to the first request indicating the access network element to receive the sensing reference signal, the first request further indicates at least one of:
a sensing reference signal configuration for the access network element to receive the sensing reference signal;
the type that needs to be sensed;
a maximum number that need to be sensed;
a sensing function or a sensing scenario that needs to be sensed;
a measurement quantity of the sensing reference signal that needs to be measured; or
a sensing result that needs to be calculated.

17. (canceled)

18. The method according to claim 16, further comprising:
receiving a sensing measurement result of a received sensing reference signal by the access network element, which is sent by the access network element in response to the first request.

19.-23. (canceled)

24. A communication device, comprising a processor, a memory, and an executable program stored in the memory, wherein when the processor runs the executable program, the communication device is caused to:
receive a first request sent by a sensing network element, wherein the first request indicates the access network element to send a sensing reference signal or to receive the sensing reference signal.

25. A non-transitory computer storage medium, wherein the non-transitory computer storage medium stores an executable program, and after the executable program is executed by a processor, the information transmission method according to claim 1 is implemented.

26. A communication device, comprising a processor, a memory, and an executable program stored in the memory, wherein when the processor runs the executable program, the communication device is caused to perform the method according to claim 11.
